(19) United States
(12) Patent Application Publication
(10) Pub. No.: US 2006/0144205 A1
(43) Pub. Date: Jul. 6, 2006

(54) Anvil for a hole punch

(75) Inventors: Robert S. Smith, Bend, OR (US); Yu Shi Cheng, Guang Dong (CN)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: TSI Manufacturing LLC

(21) Appl. No.: 11/325,392

(22) Filed: Jan. 3, 2006

Related U.S. Application Data
(60) Provisional application No. 60/641,962, filed on Jan. 5, 2005.

(51) Int. Cl. B26F 1/14

(52) U.S. Cl. 83/684

(57) ABSTRACT

Renewal of a sacrificial surface of an anvil of a hole punch is indexed and synchronized with another anvil of the hole punch, if applicable, to optimize the service life of an anvil and equalize the service lives of a plurality of anvils of a multi-hole punch.

### CROSS-REFERENCE TO RELATED APPLICATIONS

This application claims the benefit of U.S. Provisional Application No. 60/641,962, filed Jan. 5, 2005.

### BACKGROUND OF THE INVENTION

The present invention relates to a hole punch for perforating a workpiece and, more specifically, a hole punch having an anvil with a renewable surface.

Hole punches are used in homes, schools, churches and businesses for punching and organizing documents. The three-hole punch, used for punching sheets of paper to be placed in a three-ring binder, is the most popular paper punch. However, hole punches are employed to produce a single hole or multiple holes in workpieces comprising sheets of paper or other materials, such as leather or fabric, for many uses.

A hole punch for perforating a workpiece, such as a sheet of paper, typically comprises a frame that supports one or more movable punches, commonly, having a solid cross-section. The frame also includes an anvil portion that supports the workpiece during perforation. The frames of hole punches with solid punches typically include an aperture of substantially the same size and shape as the cross-section of a corresponding movable punch and spatially arranged to receive the punch when the punch is moved longitudinally to perforate a workpiece that has been placed between the end of the punch and the anvil. When the punch engages the surface of the workpiece further movement of the punch forces the portion of the workpiece that is co-extensive with the corresponding aperture into the aperture. As the movement of the punch continues, the workpiece is sheared by relative movement of the perimetrical edge of the punch and the close fitting, perimetrical edge of the aperture. The waste or chad, the portion of the workpiece sheared off by the punch, is pushed into the aperture in the anvil and is, usually, eventually pushed out of the tubular aperture in the frame as additional workpieces are punched.

This type of punch is adequate for many materials, including smaller numbers of sheets of lighter weight paper but does not work as well on many workpieces. Workpieces comprising heavier paper stock, larger numbers of sheets of paper or material having a high shear strength may be compressed and forced into the clearance between the exterior surface of the punch and the wall of the aperture without being sheared by the cooperating edges of the punch and aperture. Moreover, even if the workpiece is sheared by the adjacent edges, portions of the workpiece may be forced into the clearance between the punch and the wall of the aperture producing high operating forces or preventing the punch from retracting from the aperture.

To punch holes in heavier workpieces or workpieces comprising a material with a higher shear strength, a hole punch may comprise one or more tubular, movable punches having an annular, sharpened cutting edge on the end of the punch that engages a workpiece supported on a planar supporting surface of an anvil that is, in turn, supported by the frame of the hole punch. Manual effort or a motor, drivingly connected to the punch, urges the punch to translate in the direction of the anvil. Movement of the punch compresses the workpiece between the cutting edge and the planar surface of the anvil and further movement of the punch forces the cutting edge to pierce workpiece, shearing the material, to form a hole. The waste or chad is typically pushed into the interior of the hollow tubular punch for eventual disposal.

To protect the sharpened cutting edge of the punch, the anvil typically comprises a material, commonly plastic, that is softer than the punch. The planar surface of the anvil is sacrificed as a result of repeated contact with the cutting edge of the punch and, to maintain the effectiveness of the hole punch, the surface of the anvil that is coextensive with the cutting edge of the punch must be renewed from time-to-time. However, the portion of the anvil that is coextensive with the cutting edge of the punch is located below the punch and the supporting portions of the frame and is not clearly visible to the user. As a result, the user may move the anvil less than necessary to fully renew the portion of the surface coextensive with the end of the punch resulting in poor performance of the hole punch. Or, the user may move the anvil more than necessary consuming the anvil's sacrificial surface faster than necessary. Moreover, the user may move the anvils of a multiple hole punch unequally resulting in uneven consumption of the anvils and user frustration.

What is desired, therefore, is a hole punch having an anvil with a sacrificial surface that is controllably movable to optimize surface renewal.

### BRIEF DESCRIPTION OF THE DRAWINGS

FIG. 1 is a perspective view of a three hole punch.

FIG. 2 is a broken, partial section of the three hole punch of FIG. 1 taken along 2-2.

FIG. 3 is a top view of an anvil indexing mechanism of the punch of FIG. 2 illustrating initial movement of the control plate.

FIG. 4 is a top view of the anvil indexing mechanism of FIG. 2 illustrating rotation of the anvils.

FIG. 5 is a partially broken, top view of an anvil of the hole punch of FIG. 1 taken along 2-2.

### DETAILED DESCRIPTION OF PREFERRED EMBODIMENTS

Manual or electric motor operated hole punches are used in homes, schools, churches, and all types of offices for perforating and organizing documents. The three-hole punch is the most popular paper punch and is used for perforating paper to enable sheets to be placed in a three-ring binder. However, hole punches can produce one, two or many holes as required by a particular use and may be used to perforate workpieces other than paper, such as paste board, card board, leather and fabric.

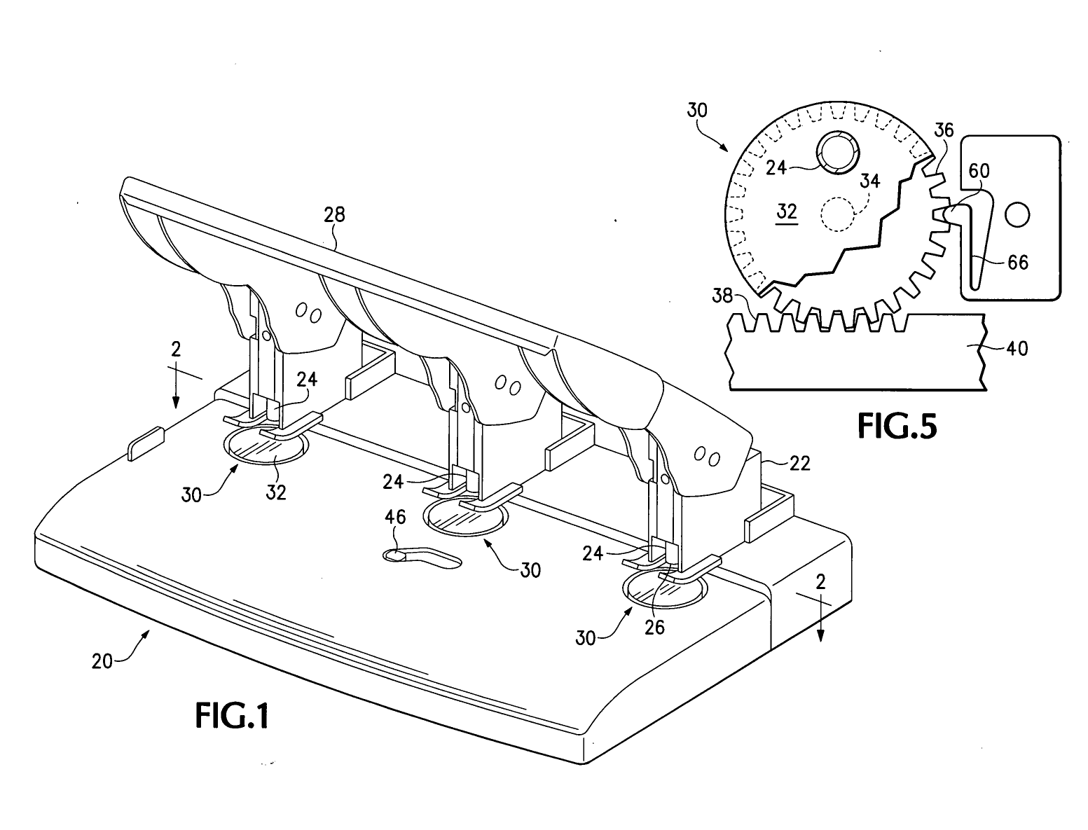

Referring in detail to the drawings where similar parts are identified by like reference numerals, and, more particularly to FIG. 1, a hole punch 20 comprises a frame 22 and one or more elongated, tubular punches 24 arranged in the frame so that each punch can translate along its longitudinal axis. The hollow, tubular punches 24 have an annular cutting edge formed, by grinding or otherwise, at one end 26 and are connected to a lever 28 or other mechanism through which manual effort or the power of a motor can be exerted to cause the punch to translate in the direction of the end having the cutting edge.

Typically, springs urge movement of the punches in a direction away from the cutting edge and support the punches so that sheets of paper or other material, into which holes will be punched, can interposed between the cutting edge of the punch and a respective anvil 30. The anvil 30 supports the workpiece so that when the punch is pressed into the surface of the workpiece, the annular cutting edge of the punch can be forced through the workpiece leaving a hole and pushing the waste or chad into the interior of the tubular punch.

To protect the cutting edge of the punch, the anvil 30 comprises a material, typically plastic, that is softer than the punch. As a result of repeated contact with the cutting edge when the punch is forced through the workpiece, the surface 32 of the anvil is sacrificed. To maintain the effectiveness of the punch, the portion of the surface of the anvil that is co-extensive with the cutting edge of the punch must, from time-to-time, be renewed. Referring to FIG. 5, the anvil 30 may comprise a circular disk that rotatable about an axis offset from the longitudinal axis of the punch 24 so that rotation of the anvil will expose a new portion of the anvil's surface to the cutting edge of the punch. However, the anvil, and, more particularly, the portion co-extensive with the end of the punch, is not clearly visible and a user may rotate the individual anvils less than or more than necessary to renew the surface and in unequal increments resulting in poor performance or rapid and unequal consumption of the plurality of anvils of a multiple hole punch. The inventor concluded that the service life of the anvils and the user's satisfaction with the hole punch could be improved if rotation of the individual anvils was synchronized so that the anvils are consumed at the same rate and indexed so that the anvils are rotated an optimal amount to renew the surface exposed to the punch.

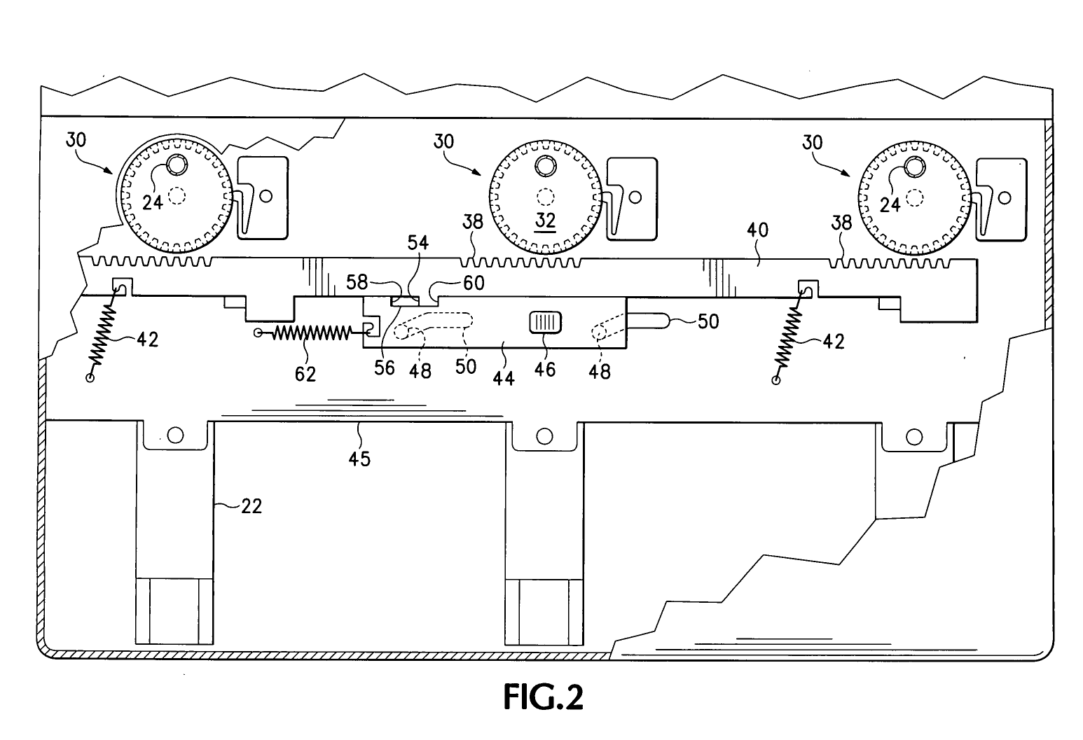

Referring to FIG. 2, the hole punch 20 includes a plurality of anvils 30 arranged so that a portion of a first surface 32 of each anvil is substantially coextensive with the end of a corresponding punch 21 and exposed to the cutting edge of the punch when the punch is moved along its longitudinal axis to produce a hole in one or more sheets of paper or other workpiece material interposed between the anvil and the cutting edge. The anvils comprise, generally, a circular disk with a planar first surface 32 arranged to support the workpiece when engaged by the cutting edge of the punch and a second surface arranged to engage the frame 22 of the hole punch and support the anvil in resisting the force exerted by the punch. The anvils are each arranged to rotate about a central axle 34 that engages a corresponding aperture in the frame 22. The aperture is offset relative to the longitudinal axis of the corresponding punch so that, when the anvil has been rotated, a different portion of the surface will be coextensive with the cutting edge on the end of the punch. An indexer, comprising a rack selectively engageable with the anvils and limitedly movable tangentially relative to the anvils, synchronizes and optimizes the rotation of the anvils and the renewal of the portion of the anvil surface coextensive with the end of the respective punch.

A plurality of cogs or gear teeth 36 is formed around the periphery of each anvil. The teeth 36 on the periphery of the anvil are selectively engageable by a plurality of mating cogs or teeth 38 formed on one edge of a slidable rack 40. The rack 40 is supported by the frame of the hole punch so that the rack is slidable both in a radial direction, normal to an axis connecting the centers of the axles 34 of the anvils, and in a direction parallel to this axis and, therefore, generally tangential to the peripheries of the circular anvils. Moving the rack 40 normal to the axis connecting the axles 34 permits selective engagement and disengagement of the teeth 38 of the rack with the teeth 36 of the anvils. Moving the rack 40 tangentially with respect to an anvil, while the teeth 38 of the rack are engaged with the teeth 36 of the anvil, will rotate the anvil so that a different portion of the first surface of the anvil is exposed to the cutting edge of the respective punch. Springs 42 connecting the rack 40 and the frame elastically urge the rack away from the peripheral edges of the anvils to disengage the teeth of the rack from the teeth of the anvils.

To renew the surfaces of the anvils 30 of the hole punch 20, a user manually engages and moves a control plate 44 that includes a first surface 46 that is accessible to one or more fingers of the user. The control plate has a second surface that slidably supports the control plate on a support plate 45 that is, in turn, supported by the frame 22 of the hole punch. A plurality of cam followers 48 project from the second surface of the control plate 44 into sliding engagement with respective slotted apertures 50 in the support plate. The apertures 50 in the support plate comprises a first portion arranged at an angle acute to an axis connecting the centers of the axles 34 of the rotatable anvils and a second portion arranged substantially parallel to that axis. When the user exerts a force to move the control plate 44, the interaction of the cam followers 48 and the sides of the first portions of the apertures 50 causes the control plate to initially move, at an angle, toward centers of the anvils. When the control plate 44 has moved sufficiently to cause the cam followers 48 to engage the second portions of the apertures, the interaction of the cam followers and the sides of the apertures will cause the control plate to move in a direction tangential to the peripheries of the anvils

The control plate 44 also includes a third surface in slidable contact with an edge of the rack 40 that is most remote from the axles of the anvils. The slidable contact enables relative translation of the rack and the control plate when the control plate is moved. A protruding portion 54 of the surface of the rack is arranged to engage a notch 56 in the surface of the control plate that contacts the rack. Relative translation of the control plate and the rack is limited by the interaction of the protruding portion and the edges 58, 60 of the control plate at the respective ends of the notch 56.

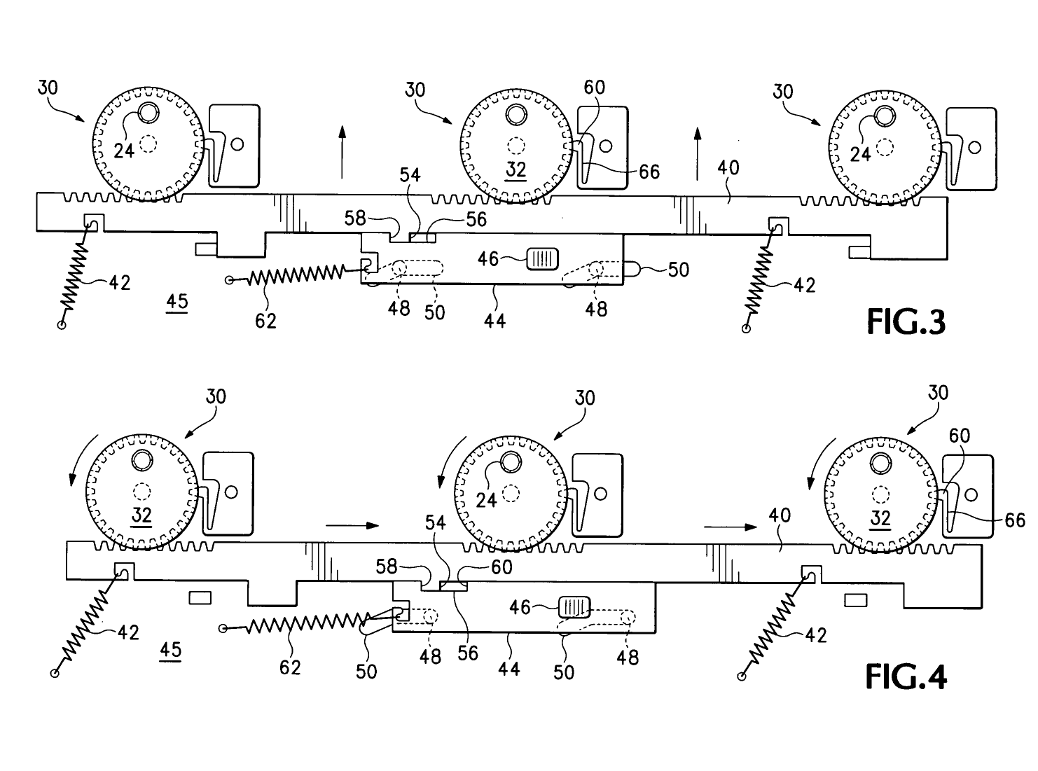

Referring also to FIG. 3, when the user exerts a force on the control plate 44, the interaction of the cam followers 48 and the sides of the slotted apertures 50 in the support plate causes the control plate and, as a consequence, the rack 40, to move toward the axles 34 of the anvils 30 bringing the teeth 38 of the rack into engagement with the teeth 36 on the peripheries of the anvils. Even though the control plate 44 translates at an angle to the axis connecting the axles of the anvils, the rack will move substantially normal to the axis because the protrusion 54 on the remote edge of the rack can translate freely in the notch in the edge of the control plate. Referring also to FIG. 4, when the cam followers 48 reach the second portions of the apertures 50 in the support plate, the interaction of the cam followers and the sides of the apertures in the support plate will cause further movement of the control plate to be tangential to the peripheries of the anvils. An edge 58 of the notch 56 in the control plate is arranged to engage the protrusion 54 on the rack when the cam followers enter the second portions of the apertures 50 in the support plate. Interaction of the protrusion 54 of the rack and the edge of the notch and movement of the control plate will cause the rack to translate tangentially with respect to the anvils and the meshing teeth 36, 38 will cause the anvils to rotate about their respective axles 34 through an angle determined by the lengths of the slotted apertures in the support plate. As a result, the anvils are synchronously indexed through a precise angle of rotation that is optimal to renew the portions of the surfaces of the anvils coextensive with the cutting edges on the ends of the respective punches.

A pawl 60 is urged into engagement with the teeth 36 of a respective anvil 30 by a cantilever spring beam 66 to prevent rotation of the anvil except when the user actuates the control plate to refresh the anvil surface. When the user releases the control plate 44, a spring 62 elastically urges the control plate toward its initial position and the springs 42 elastically urge the rack 40 toward its initial position. Initially, the control plate moves substantially tangential to the anvils as a result of interaction of the cam followers 48 and the sides of the apertures 50 in the support plate. The pawl secures the anvil and the rack remains stationary as the protrusion 54 translates in the notch of the moving control plate. When the cam followers reach the first portions of the apertures in the support plate, the control plate will move away from the anvils permitting the springs 42 to move the rack away from anvils to disengage the teeth of the anvil from the teeth of the rack and permit the rack to return to its initial position.

The indexer enables multiple anvils of a hole punch to be rotated synchronously through a precise angle to optimize and equalize the consumption of the sacrificial surfaces of the anvils.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A hole punch for perforating a workpiece, said hole punch comprising:
(a) a frame;
(b) a punch movable in said frame and having an end movable to pierce said workpiece;
(c) an anvil rotatably supported by said frame and arranged to oppose movement of said workpiece during said piercing by said end of said punch, said anvil including a first surface comprising a first surface portion substantially coextensive with said end of said punch; and
(d) an indexer to controllably displace said first surface of said anvil and move a second portion of said first surface to a position substantially coextensive with said end of said punch.

2. The hole punch of claim 1 wherein said indexer comprises a rack selectively engageable with said anvil and movable tangential to an edge of said anvil to rotate said anvil.

3. The hole punch of claim 2 further comprising a cam limiting movement of said rack tangential to said anvil.

4. The hole punch of claim 1 further comprising a pawl elastically urged to engage at least one of said first and said second anvils and resist rotation of said anvil.

5. A hole punch for perforating a workpiece, said hole punch comprising:
(a) a frame;
(b) a first punch and a second punch movable in said frame, said first and said second punches having ends movable to pierce said workpiece;
(c) a first anvil rotatably supported by said frame and arranged to oppose movement of said workpiece during said piercing by said end of said first punch, said first anvil including a first surface comprising a first surface portion substantially coextensive with said end of said first punch;
(d) a second anvil rotatably supported by said frame and arranged to oppose movement of said workpiece during said piercing by said end of said second punch, said second anvil including a first surface comprising a first surface portion substantially coextensive with said end of said second punch; and
(e) an indexer to synchronously displace said first surfaces of said first and said second anvils and move a second portion of said first surfaces to a position substantially coextensive with said respective ends of said first and said second punches.

6. The hole punch of claim 5 wherein said indexer comprises a rack selectively engageable with said first anvil and said second anvil, said rack movable tangential to said first anvil and tangential to said second anvil to synchronously rotate said first and said second anvils.

7. The hole punch of claim 5 further comprising a pawl elastically urged to engage at least one of said first and said second anvils and resist rotation of said anvil.

8. The hole punch of claim 5 wherein said indexer comprises:
(a) a rack supported by said frame and selectively movable toward said edges of said first and said second anvils to engage said anvils and movable tangential to said anvils to synchronously rotate said anvils; and
(b) a cam limiting movement of said rack tangential to said anvils.

9. The hole punch of claim 8 further comprising a pawl elastically urged to engage at least one of said first and said second anvils and resist rotation of said anvil.

10. A hole punch for perforating a workpiece, said hole punch comprising:
(a) a frame;
(b) a first punch and a second punch movable in said frame, said first and said second punches having ends movable to pierce said workpiece;
(c) a first anvil rotatably supported by said frame and arranged to oppose movement of said workpiece during piercing by said end of said first punch, said first anvil including a first surface portion substantially coextensive with said end of said first punch;
(d) a second anvil rotatably supported by said frame and arranged to oppose movement of said workpiece during piercing by said end of said second punch, said second anvil including a first surface portion substantially coextensive with said end of said second punch; and
(e) a rack including a tooth, said rack movable radially with respect said first and said second anvils to engage said tooth with a tooth on said first anvil and a tooth on said second anvil and movable tangentially with respect to said anvils to rotate said anvils and arrange a second surface portion of said first anvil coextensive with said end of said first punch and a second portion of said second anvil coextensive with said end of said second punch.
